(19) United States
(12) Patent Application Publication
(10) Pub. No.: US 2026/0184335 A1
(43) Pub. Date: Jul. 2, 2026

(54) AUTONOMOUS VEHICLES AND METHODS FOR TRAINING AUTONOMOUS VEHICLES ON EDGE CASE SCENARIOS

(71) Applicant: Toyota Jidosha Kabushiki Kaisha, Toyota-shi Aichi-ken (JP)

(72) Inventor: Divya Garikapati, San Jose, CA (US)

(73) Assignee: Toyota Jidosha Kabushiki Kaisha, Toyota-shi Aichi-ken (JP)

(21) Appl. No.: 19/005,258

(22) Filed: Dec. 30, 2024

(51) Int. Cl. B60W 60/00; B60W 30/09; B60W 30/12; B60W 30/14; G05B 13/02; G05D 1/222; G05D 1/225

(52) U.S. Cl. CPC B60W 60/001; B60W 30/09; B60W 30/12; B60W 30/14; G05B 13/028; B60W 2556/45; G05D 1/222; G05D 1/225

(57) ABSTRACT

In one embodiment, a method of training an autonomous vehicle model includes autonomously controlling an autonomous vehicle within an environment using autonomous vehicle model, receiving sensor data, where the sensor data corresponds with one or more of operations of the autonomous vehicle and the environment generating an autonomous interrupt request based at least in part on the sensor data, transmitting the autonomous interrupt request to a remote operator, receiving control signals from the remote operator, controlling the autonomous vehicle according to the control signals from the remote operator, collecting, while the autonomous vehicle is controlled using the control signals from the remote operator, additional sensor data, and training the autonomous vehicle model by providing the additional sensor data and the control signals to the autonomous vehicle model.

### BACKGROUND

Autonomous vehicles, such as Level 5 autonomous vehicles, are capable of navigating the roads of an environment without human control. Such autonomous vehicles may include an autonomous driving system having a trained model that is operable to take in sensor data regarding the vehicle and the environment, and produce trajectories that are used to operate the vehicle control systems of the vehicle to drive the vehicle within the environment.

In many instances, an autonomous vehicle may encounter a new scenario, such as an edge case that rarely occurs. Examples may be a uniquely configured intersection, a crest of a hill providing short-distance visibility, and uncharacteristic driving behavior of other vehicles within the environment. When the autonomous vehicle encounters such scenarios, the autonomous driving system may produce a low confidence value, causing it to take remedial action, such as pulling over and parking or other types of actions.

Sensor data surrounding the new scenario may be gathered off-line at a later time, evaluated, and then used to further train or otherwise update the trained model of the autonomous vehicle system so that the autonomous vehicle subsequently learns how to operate in the new scenario. However, such off-line processes take time and can delay the updating of the trained model, and can also increase the cost associated with updating the trained model with new scenarios. Further, sensor data reflective how a human driver would navigate the scenario is not available because the autonomous vehicle took the remedial action, which is not how a human would handle the scenario.

Accordingly, alternative systems and methods for training an autonomous vehicle model may be desired.

### SUMMARY

In one embodiment, a method of training an autonomous vehicle model includes autonomously controlling an autonomous vehicle within an environment using autonomous vehicle model, receiving sensor data, where the sensor data corresponds with one or more of operations of the autonomous vehicle and the environment generating an autonomous interrupt request based at least in part on the sensor data, transmitting the autonomous interrupt request to a remote operator, receiving control signals from the remote operator, controlling the autonomous vehicle according to the control signals from the remote operator, collecting, while the autonomous vehicle is controlled using the control signals from the remote operator, additional sensor data, and training the autonomous vehicle model by providing the additional sensor data and the control signals to the autonomous vehicle model.

In another embodiment, a vehicle includes a plurality of sensors operable to produce sensor data of at least one of operation of the autonomous vehicle and the environment. The vehicle also includes a vehicle control system operable to move the autonomous vehicle within the environment. The vehicle further includes an autonomous vehicle model trained on autonomously controlling the autonomous vehicle within the environment, one or more processors, and a non-transitory computer-readable medium. The non-transitory computer-readable medium stores instructions that, when executed by the one or more processors, causes the one or more processors to autonomously control the autonomous vehicle within the environment using the autonomous vehicle model and the vehicle control system, generate an autonomous interrupt request based at least in part on the sensor data, transmit the autonomous interrupt request to a remote operator, receive control signals from the remote operator, control, using the vehicle control system, the autonomous vehicle according to the control signals from the remote operator, collect, while the autonomous vehicle is controlled using the control signals from the remote operator, additional sensor data, and train the autonomous vehicle model by providing the additional sensor data and the control signals to the autonomous vehicle model.

### BRIEF DESCRIPTION OF THE SEVERAL VIEWS OF THE DRAWINGS

FIG. 1 illustrates an example autonomous vehicle according to one or more embodiments described and illustrated herein.

FIG. 2 illustrates an example autonomous vehicle communicating with a remote operator according to one or more embodiments described and illustrated herein.

FIG. 3 illustrates example components of an example autonomous vehicle according to one or more embodiments described and illustrated herein.

FIG. 4A illustrates an example human operator of a remote operator according to one or more embodiments described and illustrated herein.

FIG. 4B illustrates an example expert system remote operator according to one or more embodiments described and illustrated herein.

FIG. 5 illustrates an example process flow according to one or more embodiments described and illustrated herein.

FIG. 6 illustrates an example method for autonomously controlling an autonomous vehicle according to one or more embodiments described and illustrated herein.

### DETAILED DESCRIPTION

Embodiments of the present disclosure are directed to autonomous vehicles as well as systems and methods for training an autonomous vehicle model. Presently, sensor data from an autonomous vehicle is retrieved, analyzed and used for retraining in an off-line process following an autonomous driving session performed by an autonomous vehicle. For example sensor data of the autonomous vehicle is generated and stored while the autonomous vehicle drives within an environment. This sensor data is later analyzed, such as categorization by a driving scenario or maneuver, and may be used to further train the autonomous vehicle model so that performance of the autonomous vehicle can be increased.

When an autonomous vehicle encounters a scenario for which it is unfamiliar, the autonomous vehicle model may not have confidence that it can produce a satisfactory trajectory to navigate the scenario. Thus, the autonomous vehicle model may produce a low confidence value that is below a threshold value. In such a situation, the autonomous vehicle may be programmed to perform a remedial maneuver, such as pulling off to the side of the road and stopping, or taking some other action. The remedial maneuver may not correspond with how a human driver would manually operate a vehicle in such a scenario. Therefore, the autonomous vehicle model should be trained to handle many different scenarios, some of which may be rare edge cases. However, because there is no human driver in an autonomous vehicle, no sensor data can be generated with respect to how a human driver would operate the vehicle in the scenario because the autonomous vehicle takes the remedial action rather than navigating the environment as a human driver would.

In embodiments of the present disclosure, a remote operator controls the vehicle during a scenario that the autonomous vehicle cannot perform while operating in an autonomous driving mode. For any number of reasons, the autonomous vehicle generates an autonomous interrupt request that prompts control by a remote operator. As non-limiting examples, the autonomous interrupt request may be generated when the autonomous vehicle model generates a confidence value that is below a threshold value (or does the confidence of the autonomous vehicle does not satisfy some other metric), or when an assistive driving system (e.g., a collision avoidance system) produces an assistive driving signal that briefly takes over control of the autonomous vehicle.

The remote operator provides wireless control signals from a remote location that are used by the autonomous vehicle to navigate the environment of the particular scenario. The remote operator may be a human operator at a remote operation facility that remotely controls the autonomous vehicle until it completes the driving scenario and it is satisfactory for the autonomous vehicle to resume autonomous control. As another example, the remote operator may be an expert system having a trained model that is more capable than the autonomous vehicle model running on the autonomous vehicle due to power and processing constraints of the autonomous vehicle. As described in more detail below, the trained model of the expert system may include one or more large language models trained in the rules of the road of various jurisdictions so that the remote operator can expertly control the autonomous vehicle in many different scenarios. The remote operator as an expert system may be executed at a dedicated facility, or be hosted in a cloud environment, for example.

While the autonomous vehicle is being remotely controlled, additional sensor data of the autonomous vehicle is generated by the various sensors of the vehicle. This additional sensor data is indicative of how the autonomous vehicle should approach maneuvering for the particular scenario for which there was an autonomous interrupt request. In embodiments, the additional sensor data is used to further train the autonomous vehicle model such that the autonomous vehicle will learn how to drive in the environment of the scenario for which there was a takeover by a remote operator. Thus, the remote operator may not be needed in similar scenarios in the future.

Various embodiments of autonomous vehicles and systems and methods for training autonomous vehicle models are described in detail below.

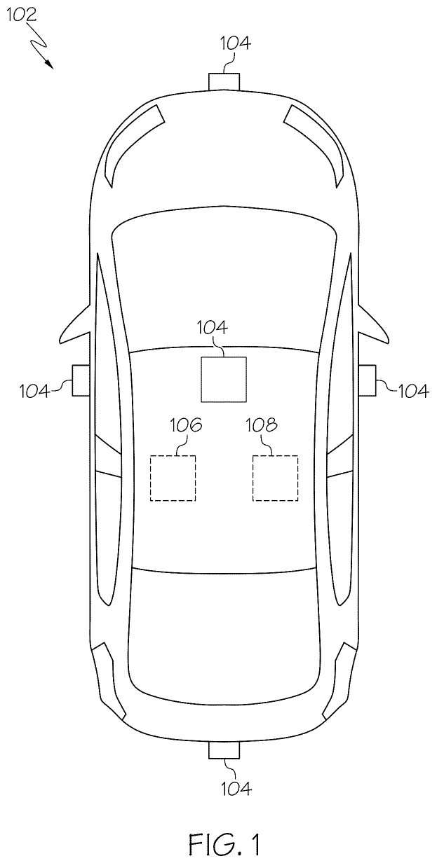

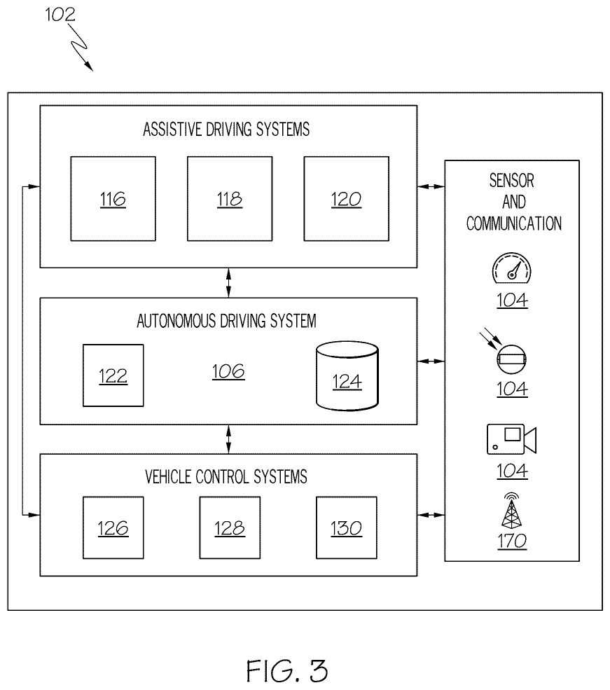

Referring now to FIG. 1, an example autonomous vehicle 102 is schematically illustrated. The autonomous vehicle 102 may be any type of autonomous vehicle 102. For example, the autonomous vehicle 102 may be a Level 4 or a Level 5 autonomous vehicle capable of driving without human intervention. The illustrated autonomous vehicle 102 has any number of sensors 104, such as cameras, lidar sensors, radar sensors, proximity sensors, speedometers, inertial measurement units (IMU), steering angle sensors, braking sensors, occupancy sensors, and any other sensor capable of detecting an attribute of the autonomous vehicle 102 and the environment in which the autonomous vehicle 102 is navigating. The example autonomous vehicle 102 also includes a global positioning system (GPS) device 108 configured to receive locational data from one or more satellites orbiting the Earth. As described in more detail below, the autonomous vehicle 102 has an autonomous driving system 106 capable of receiving sensor data from the plurality of sensors 104, the GPS device 108 and any other data source, and generating a trajectory that is used by the autonomous vehicle 102 to drive within the environment. The autonomous driving system 106 includes an autonomous vehicle model 124 (see FIG. 3) that is trained to develop valid trajectories for the autonomous vehicle 102. The autonomous driving system 106 may include other modules, such as a heuristic rules-based module that receives the trajectories from the autonomous vehicle model 124 for validation prior to generating control signals in some embodiments. In other embodiments, no heuristic rules-based module is utilized.

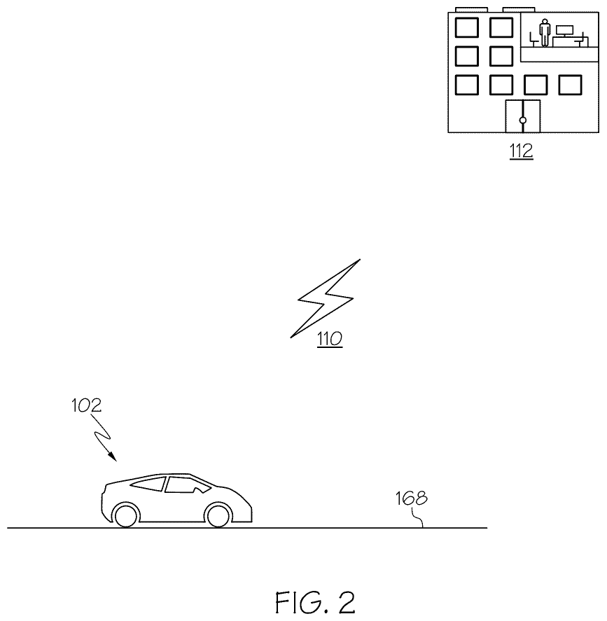

FIG. 2 illustrates an autonomous vehicle 102 driving on a road 168 within an environment. The autonomous vehicle 102 is autonomously driven by the autonomous driving system 106 without a human driver. As the autonomous vehicle 102 drives on the road 168, its sensors 104 generate data regarding both the operation of the vehicle (e.g., speed, steering angle, acceleration, and any other data indicative of the operation of the autonomous vehicle 102) and the environment (e.g., data regarding other vehicles on the road 168, pedestrians, number of lanes, curvature of the road, and any other data regarding attributes of the environment).

In most cases, the autonomous vehicle 102 can successfully navigate the road 168 without any additional assistance. However, in some scenarios the autonomous driving system 106 lacks the confidence that it can produce a successful trajectory based on the sensor data it receives. The uncertainty may be due to a driving scenario that the autonomous driving system 106 was not trained for, such as an edge case scenario that rarely occurs. Embodiments are not limited by any type of scenario that may be problematic for the autonomous driving system 106. Non-limiting examples of problematic scenarios include a group of bicyclists sharing the road 168 with the autonomous vehicle 102, an intersection having a sharp right or left turn, a hill that limits the view of the sensors 104 beyond the crest of the hill, dense fog, and animals in the road 168. Any number of scenarios may cause the autonomous driving system 106 to lack confidence in developing successful trajectories. However, a human driver would be able to perform maneuvers to navigate these scenarios handedly.

During a problematic scenario, the autonomous driving system 106 of the autonomous vehicle 102 may generate an autonomous interrupt request, or otherwise report that it cannot generate a satisfactory trajectory for the particular scenario. The autonomous interrupt request may be generated when the autonomous driving system 106 has a confidence value that is below a threshold value, or when some other confidence metric is not satisfied. As another example, the autonomous interrupt request may be generated when an assistive driving signal of the autonomous vehicle 102 is activated and produces one or more signals to control the autonomous vehicle 102. For example, the collision avoidance system 120 (see FIG. 3) may generate a braking control signal, which is indicative of a scenario where the trajectory of the autonomous driving system 106 is not satisfactory. In this case, an autonomous driving autonomous interrupt request may be generated. As another example, if a lane keep assist system 116 frequently generates a control signal to keep the autonomous vehicle 102 within the lane lines, it may be indicative that the trajectory generated by the autonomous driving system 106 is not satisfactory and an autonomous interrupt request may be generated.

The autonomous interrupt request may be provided to the remote operator 112 operator by one or more wireless signals 110, such as through a cellular communication network, a satellite communication network or any other communication network. The remote operator 112 receives the autonomous interrupt request (or any other signal or command indicating that remote control of the autonomous vehicle 102 is warranted) and then produces control signals that are then transmitted to the autonomous vehicle 102 as wireless signals 110 over the communication network. The control signals may include, without limitation, acceleration signals, braking signals, and steering signals. The remote operator 112 can successfully navigate the vehicle through the particular scenario until it is appropriate to pass control of the autonomous vehicle 102 back to the autonomous driving system 106.

While the remote operator 112 is controlling the autonomous vehicle 102, the sensors 104 continue to generate additional sensor data. This additional sensor data may be useful information for learning how to properly and successfully navigate a vehicle during the particular scenario. The additional sensor data provides information such as velocity, acceleration, deceleration, steering angle, path, and other information regarding attributes of the trajectories taken by the autonomous vehicle 102 while under remote control.

This additional sensor data is then provided to the autonomous driving system 106 as training data to further train the autonomous driving system 106 on how to develop trajectories for the particular scenario that caused the autonomous interrupt request. More particularly, sensor data within a time window of the autonomous interrupt request may be provided to the autonomous driving system 106 as training data. The time window may start a certain amount of time before the autonomous interrupt request and may end a certain amount of time after autonomous interrupt request or after control of the vehicle is once again passed to the autonomous driving system 106. In this manner, the sensor data is reflective of both what driving conditions caused the scenario to occur, and what trajectories the remote operator 112 provided to address the driving scenario. In some embodiments, a classifier is used to classify the driving scenario. The driving classification may also be provided as training data for the autonomous driving system 106. Driving classifications are not limited by this disclosure, and may include intersection traversal, merging, lane change, road agent issues, pedestrian, and sensor occlusion.

Referring now to FIG. 3, additional components of an example autonomous vehicle 102 are schematically illustrated. The autonomous vehicle 102 includes various assistive driving systems, such as lane keep assist system 116, adaptive cruise control system 118 and collision avoidance system 120. These systems may be used by the autonomous vehicle 102 to provide control signals when needed and, as described above, to generate an autonomous interrupt request if warranted. The autonomous vehicle 102 further includes vehicle control systems, such as, without limitation, a propulsion system 126 (e.g., a motor or engine and an accelerator) for providing mechanical propulsion of the autonomous vehicle 102, a steering system 128 for laterally controlling the movement of the autonomous vehicle 102, and a braking system 130 for decelerating the autonomous vehicle 102. The vehicle control systems receive control signals from the autonomous driving system 106, the assistive driving systems or the remote operator depending on the situation. The control signals control the various vehicle control systems such that the autonomous vehicle 102 completes successful trajectories within the environment. As stated above, the autonomous vehicle 102 also includes a plurality of sensors, such as a speedometer, lidar sensor, radar, cameras, and other sensors capable of producing sensor data indicative of attributes of the autonomous vehicle 102 and the environment. The autonomous vehicle 102 further includes networking hardware 170 to produce and receive the wireless signal 110 for communication between the autonomous vehicle 102 and the remote operator 112.

The autonomous driving system 106 includes, without limitation, an autonomous driving stack stored in a non-transitory computer-readable medium 122 that includes software components and sub-components for completing the task of autonomously controlling the autonomous vehicle 102 within the environment. The autonomous driving system 106 further includes the autonomous vehicle model 124 that is trained using training data as well as the sensor data surrounding autonomous interrupt requests and remote operator 112 control as described above. Each of the assistive driving systems, the autonomous driving system 106, the vehicle control systems, and the sensor and communication devices may communicate with one another to provide data for successful navigation within the environment.

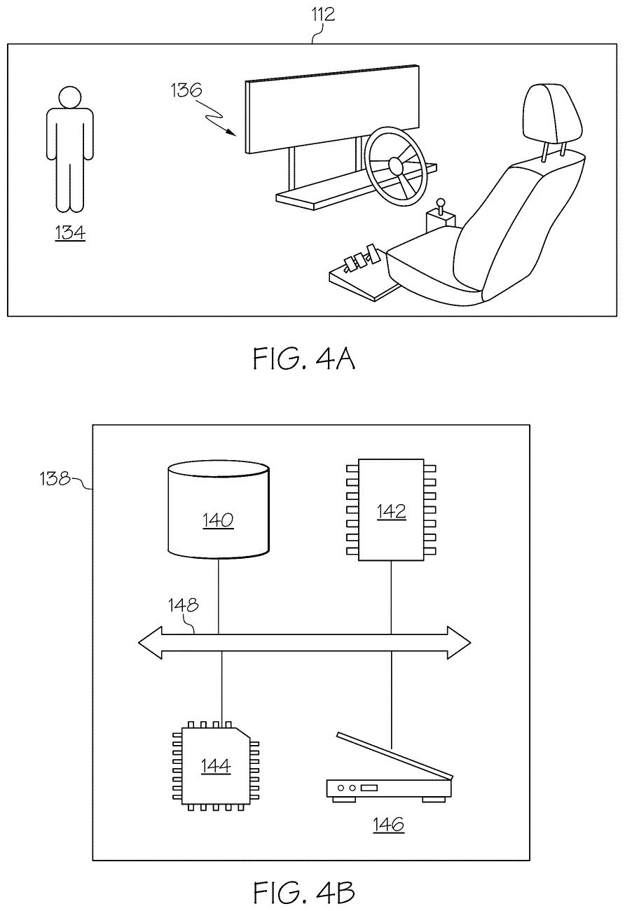

Referring now to FIG. 4A, an example remote operator 112 configured as a human operator 134 is illustrated. As a non-limiting example, the human operator 134 may be an employee at an office or other location that provides remote vehicle control services. The human operator 134 interfaces with a control system 136 to produce control signals that are then transmitted to the autonomous vehicle 102 by way of wireless signals 110. The control system may have input devices similar to that of a vehicle, such as an acceleration pedal, a brake pedal, and a steering wheel. For example, the human operator 134 may sit in a mock vehicle cockpit having the various input devices of a vehicle, as well as an electronic display that shows the environment of the remote autonomous vehicle 102 so that the human operator 134 may use the control system 136 to produce control signals that control the autonomous vehicle 102. In other embodiments, the human operator 134 may use one or more joysticks as input devices. Other input device capable of producing the control signals may also be utilized. The output of these input devices of the control system 135 can then be transmitted over one or more communication networks to the autonomous vehicle 102 so that the autonomous vehicle 102 can be controlled remotely.

When remote operator 112 receives an autonomous interrupt request, a communication channel is established between the human operator 134/control system 136 so that sensor data are provided to the remote operator 112, and control signals are provided to the autonomous vehicle 102. For example, a video feed using camera data from the sensor 104 of the autonomous vehicle 102 is provided to and displayed on the control system 136 so that the human operator 134 can view the environment and produce vehicle control signals accordingly. These control signals are then provided to the autonomous vehicle.

FIG. 4B illustrates another remote operator 138 that is configured as an expert system that is not human controlled. The remote operator 138 of FIG. 4B may be an autonomous driving system that is more advanced and capable than the autonomous driving system 106 that is run on the autonomous vehicle 102 due to the battery power and computing capability limitations of the autonomous vehicle 102. Generally, when an autonomous interrupt request is received by the remote operator 138, control of the autonomous vehicle 102 is passed to the expert system of the remote operator 138, which produces control signals that are provided to the autonomous vehicle 102 so that the autonomous vehicle 102 can successfully navigate the scenario encountered by the autonomous vehicle 102. The remote operator as an expert system may be executed at a dedicated facility, or be hosted in a cloud environment, for example.

The example remote operator 138 includes one or more non-transitory computer-readable memory components 142 and one or more processors 144 that are operable to execute instructions stored on the one or more memory components 142 to perform the remote control vehicle operations described herein. The one or more memory component 142 may store a non-transitory computer-readable medium, one or more trained autonomous vehicle models, and/or other software components for autonomously controlling the autonomous vehicle 102 remotely.

The remote operator 138 further includes networking hardware 146 operable to communicate with the autonomous vehicle 102 over one or more communication networks. For example, the networking hardware 146 enables control signals generated by the remote operator 138 to be transmitted to the autonomous vehicle 102, and for sensor data to be transmitted from the autonomous vehicle 102 to the remote operator 138.

The example remote operator 138 further includes one or more large language models 140 that provide knowledge to the remote operator 138. For example, the one or more large language models 140 may be trained on the rules of the road for various jurisdictions. Different jurisdictions have different rules of the road. The rules of the road of one country or state may be different from the rules of the road for another country or state. The remote operator 138 determines the location and jurisdiction of the autonomous vehicle 102 from the sensor data provided to it, and then selects the appropriate large language model 140 for the jurisdiction. The remote operator 138 then uses the rules of the road provided by the large language model 140 (or other source) for that jurisdiction.

In some embodiments, the remote operator 138 may include many trained models for many individual scenarios. Thus, each model may be an expert in navigating a particular scenario. As a non-limiting example, these expert models may be configured as large language models 140. One model may be trained in navigating a vehicle when there is an animal in the road, while another model may be trained in navigating a vehicle when there is dense fog.

The remote operator 138 receives the sensor data from the autonomous vehicle 102 and makes a decision regarding the type of driving scenario. For example, the remote operator 138 may perform a classification or categorization algorithm on the sensor data to determine the scenario experienced by the autonomous vehicle 102. Any known or yet-to-be-developed classification or categorization algorithm may be utilized. In the case of a foggy environment, the remote operator 138 may use the sensor data (e.g., camera data) and categorize the driving scenario as a foggy driving scenario. The remote operator 138 may then utilize a trained model that is trained in foggy driving scenarios. It should be understood that in other embodiments, a single trained model is utilized rather than a plurality of specialized trained models.

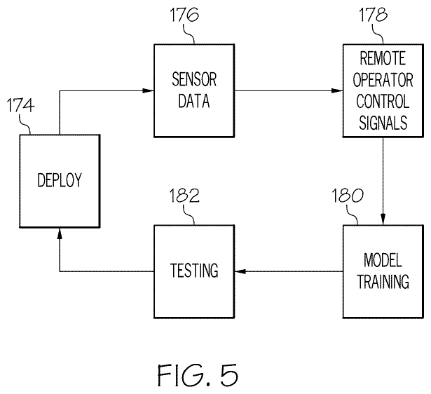

FIG. 5 illustrates an example process flow according to one or more embodiments of the present disclosure. At block 176 the autonomous vehicle 102 autonomously navigates the environment using one or more autonomous vehicle models 124 while sensor data generated by one or more sensor 104 of the vehicle is stored. The sensor data, as described below, may relate to any vehicular operation or attribute of the environment. When there is an autonomous interrupt request, the process moves to block 178, where the autonomous vehicle 102 is remotely controlled, either by a human operator or an expert system as described above. In addition to the sensor data, the remote operator control signals used to remotely control the autonomous vehicle 102 are stored.

The sensor data and the remote operator control signals are then used to further train the autonomous vehicle model 124 at block 180. This offline training process enables the autonomous vehicle model 124 to learn from the control signals provided by the remote operator with respect to the autonomous interrupt request, which may be the result of an edge case that is unfamiliar to the autonomous vehicle model 124. In this manner, the autonomous vehicle model 124 learns how to navigate edge cases.

At block 182 the updated autonomous vehicle model 124 is then evaluated for performance in a testing process. In one example, the autonomous vehicle model 124 is tested in a simulated environment. The simulated environment may put a virtual vehicle operating with the updated autonomous vehicle model 124 through a simulated edge case that caused the autonomous interrupt request to determine how well the autonomous vehicle model 124 performs. In another example, the autonomous vehicle model 124 is provided on a physical vehicle that executes the autonomous vehicle model 124 on a closed-course. After it is determined that the autonomous vehicle model 124 performs according to quality standards, it is then deployed to autonomous vehicles, such as by a software update (e.g., an over-the-air software update or a wired software update). The process continues to block 176 where autonomous vehicles operate and produce sensor data. In this manner, the autonomous vehicle model 124 may be continuously trained and improved to handle new edge cases as they are encountered.

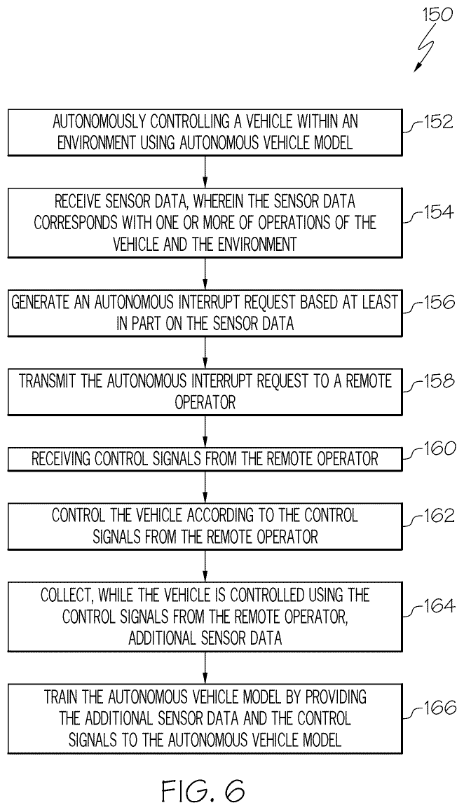

Referring now to FIG. 6, a flowchart of an example method 150 for autonomously controlling an autonomous vehicle 102 is illustrated. In block 152, the method 150 includes autonomously controlling an autonomous vehicle 102 within an environment using an autonomous vehicle model. In block 154, while the autonomous vehicle is autonomously driving, sensor data is received and stored. The sensor data corresponds with one or more of operations of the autonomous vehicle and the environment, such as the speed of the vehicle and road agents in the environment (e.g., other vehicles and pedestrians).

In block 156, the method includes generating an autonomous interrupt request based at least in part on the sensor data. For example, the autonomous driving system 106 may produce a confidence value that is below a threshold value, or some other event or reason occurs whereby the autonomous driving system 106 produces an autonomous interrupt request that requests a take-over of control of the autonomous vehicle 102.

In block 158, the method continues by transmitting the autonomous interrupt request to a remote operator, which evaluates the sensor data and produces control signals corresponding with one or more trajectories. In block 160, the autonomous vehicle 102 receives the control signals from the remote operator. In block 162, the method continues by controlling the autonomous vehicle according to the control signals provided by the remote operator. In 164, the method collects additional sensor data while the autonomous vehicle is controlled using the control signals from the remote operator. In block 166, the method continues by training the autonomous vehicle model by providing the additional sensor data and the control signals to the autonomous vehicle model.

It should now be understood that embodiments of the present disclosure are directed to autonomous vehicles as well as systems and methods for training an autonomous vehicle model. In embodiments, a remote operator controls the vehicle during a scenario that the autonomous vehicle cannot perform in an autonomous driving mode. Additional sensor data is collected while the autonomous vehicle is remotely controlled. This additional sensor data is used to further train the autonomous vehicle model so that, over time, the autonomous vehicle model improves performance and can successfully navigate through new and/or difficult driving scenarios.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method of training an autonomous vehicle model, the method comprising:
autonomously controlling an autonomous vehicle within an environment using the autonomous vehicle model;
receiving sensor data, wherein the sensor data corresponds with one or more of operations of the autonomous vehicle and the environment
generating an autonomous interrupt request based at least in part on the sensor data;
transmitting the autonomous interrupt request to a remote operator;
receiving control signals from the remote operator;
controlling the autonomous vehicle according to the control signals from the remote operator;
collecting, while the autonomous vehicle is controlled using the control signals from the remote operator, additional sensor data; and
training the autonomous vehicle model by providing the additional sensor data and the control signals to the autonomous vehicle model.

2. The method of claim 1, further comprising classifying a driving scenario within a time window surrounding generation of the autonomous interrupt request based on the sensor data and the additional sensor data.

3. The method of claim 2, wherein training the autonomous vehicle model by providing the additional sensor data to the additional sensor data trains the autonomous vehicle model by a classified driving scenario.

4. The method of claim 1, wherein the remote operator is human controlled.

5. The method of claim 1, wherein the remote operator is an autonomous remote control system.

6. The method of claim 5, wherein the autonomous remote control system comprises a large language model.

7. The method of claim 5, wherein the autonomous remote control system is trained on rules of a jurisdiction.

8. The method of claim 1, wherein the autonomous interrupt request is generated when a confidence value of the autonomous vehicle model is below a threshold value based on the sensor data.

9. The method of claim 1, wherein the autonomous interrupt request is generated after receiving an assistive driving signal from an assistive driving system.

10. The method of claim 9, wherein the assistive driving system comprises a lane keep assist system, a collision avoidance system, or an adaptive cruise control system.

11. An autonomous vehicle comprising:
a plurality of sensors operable to produce sensor data of at least one of operation of the autonomous vehicle and an environment;
a vehicle control system operable to move the autonomous vehicle within the environment;
an autonomous vehicle model trained on autonomously controlling the autonomous vehicle within the environment;
one or more processors; and
a non-transitory computer-readable medium storing instructions that, when executed by the one or more processors, to:
autonomously control the autonomous vehicle within the environment using the autonomous vehicle model and the vehicle control system;
generate an autonomous interrupt request based at least in part on the sensor data;
transmit the autonomous interrupt request to a remote operator;
receive control signals from the remote operator;
control, using the vehicle control system, the autonomous vehicle according to the control signals from the remote operator;
collect, while the autonomous vehicle is controlled using the control signals from the remote operator, additional sensor data; and
train the autonomous vehicle model by providing the additional sensor data and the control signals to the autonomous vehicle model.

12. The autonomous vehicle of claim 11, wherein the computer-readable instructions further cause the vehicle to classify a driving scenario a time window surrounding generation the autonomous interrupt request based on the sensor data and the additional sensor data.

13. The autonomous vehicle of claim 12, wherein the autonomous vehicle model is further trained by a classified driving scenario.

14. The autonomous vehicle of claim 11, wherein the remote operator is human controlled.

15. The autonomous vehicle of claim 11, wherein the remote operator is an autonomous remote control system.

16. The autonomous vehicle of claim 15, wherein the autonomous remote control system comprises a large language model.

17. The autonomous vehicle of claim 15, wherein the autonomous remote control system is trained on rules of a jurisdiction.

18. The autonomous vehicle of claim 11, wherein the autonomous interrupt request is generated when a confidence value of the autonomous vehicle model is below a threshold value based on the sensor data.

19. The autonomous vehicle of claim 11, wherein the autonomous interrupt request is generated after receiving an assistive driving signal from an assistive driving system.

20. The autonomous vehicle of claim 19, wherein the assistive driving system comprises a lane keep assist system, a collision avoidance system, or an adaptive cruise control system.
